(19) United States
(12) Patent Application Publication
(10) Pub. No.: US 2023/0394100 A1
(43) Pub. Date: Dec. 7, 2023

(54) Webpage Title Generator

(71) Applicant: Ellipsis Marketing LTD, Worthing (GB)

(72) Inventor: Alex Denning, Oxford (GB)

(21) Appl. No.: 17/829,539

(22) Filed: Jun. 1, 2022

(51) Int. Cl. G06F 16/9538; G06F 16/906

(52) U.S. Cl. CPC G06F 16/9538; G06F 16/906

(57) ABSTRACT

A computing device receives a request for an assessment of a target keyword. The keyword includes at least one word which is input to a search engine by a user to conduct a search for content. The computing device also obtains current search results for the target keyword on at least one search engine, wherein the current search results are ranked and include content information. The computing device then selects a shortlist of search results from the obtained current search results and obtaining marketing data for the target keyword. A plurality of titles for the target keyword is obtained and evaluated to classify each combination of title and target keyword. The plurality of titles may be generated by a title generator using the shortlist of the obtained search results.

### FIELD

The present techniques relate to systems and methods for generating titles for webpages of websites using artificial intelligence (AI) and machine learning (ML). In particular, the systems and methods of the present techniques use target keywords which are input into search engines.

### BACKGROUND

Companies utilize several digital strategies to drive online awareness. The strategies may include paid advertisement, social media, digital PR, owned media, and search engine optimisation (SEO) content. While paid advertisements are effective at driving immediate traffic to the company website(s) they are costly and require routine updates with new content. Social media and digital PR are effective at driving sustained traffic over the long term but require a significant upfront time and costs to invest in relationships with social media influencers. The SEO content is beneficial in that once a company's site and keywords are ranked on search engines (e.g. Google™), such ranking is sustained for an extended period of time which produces long-term traffic. Therefore, SEO content is one of the most effective long-term marketing channels. However, the challenge is that it takes significant time to create SEO content and attain an advantageous rank in search engines.

SEO Content refers to content marketing specifically trying to get clicks, leads, and sales directly from search engines. In other words, content marketing is a marketing channel where you publish content on your website with the aim of promoting your product or service. There are many factors involved in getting the ranking in the search engine (e.g. Google™, Bing). Two of the most important are the keyword and title selections. The keyword is the word (or phrase) entered by a potential customer who is searching for a product or service. If the wrong keyword is selected, then the company will waste resources by producing the content and paying for the keyword because nobody is searching for the content. For example, if “patent attorney for marketing agencies” is chosen as a keyword, and nobody is searching for this, it will result in a waste of resources. The title is a phrase selected by the service or product provider to indicate what service or product they are offering. If the wrong title is selected, Google™ or any other search engine will not show the content as it does not match the answer people are looking for.

There are existing example of title generators (e.g. https://www.title-generator.com/). Including ones which use general AI. The applicant has identified deficiencies with such title generators in generating titles for Search Engine Optimization (SEO) content. Many of these deficiencies are addressed by the solutions described in detail in this application.

### SUMMARY

Examples described herein include systems and methods for generating webpage titles based on one or more target keywords using one or more machine learning models. In one example, the system can include a computing device which comprises said at least one machine learning model or is connectable to said at least one machine learning model. The system can include a non-transitory, computer-readable medium containing instructions and processing circuitry that executes the instructions to perform stages or steps.

In a first stage, a request for an assessment of a target keyword can be received at the computing device, wherein the keyword comprises at least one word which is input to a search engine by a user to conduct a search for content. Current search results for the target keyword on at least one search engine can then be obtained. These current search results can be ranked and can include content information. A shortlist of search results can then be selected from the obtained current search results. A plurality of titles for the target keyword can then be generated using the shortlist of the obtained search results, for example using a title generator, e.g. a machine learning model which has been trained to generate titles.

The plurality of generated titles can then be evaluated to classify each combination of title and target keyword. The evaluation can be done by an evaluation model in the form of a machine learning model which has been trained to classify each combination of title and target keyword. The evaluation may use marketing data for the target keyword which can be obtained from a data service. The evaluation may use the content data for the shortlist of search results which was obtained from the search engine. Based on the classification obtained using the evaluation model, at least one optimal title can then be output to a user, e.g. on a user interface.

### BRIEF DESCRIPTION OF DRAWINGS

The detailed description refers to the following accompanying drawings. The features which are the same or substantially similar retain the same reference numbers in the drawings and throughout the description. Therefore, a repeated description of such features is omitted. Components within the drawings are not necessarily to scale. All examples described in the drawings may be combined together unless it is explicitly stated otherwise.

FIG. 1 is a system diagram of the system of the present techniques;

FIG. 2 is a flowchart of the method of the present techniques;

FIG. 3 is an exemplary result which may be used to select a keyword for use in the method of FIG. 2;

FIG. 4a is a table showing a selection of top ranking titles obtained from the searching step in FIG. 2;

FIG. 4b plots the probability (confidence) level that a fit is “no”;

FIG. 4c plots the number of rows of test data which are in the top, middle and bottom rows shown in FIG. 4b;

FIG. 4d plots the average probability, for each of the top, middle and bottom rows, of FIGS. 4b and 4c;

FIG. 4e is an example output showing a selection of top ranked keyword and title pairs together with additional information;

FIG. 5 is a flowchart for training and using a title generation model which may be used in the method of FIG. 2;

FIG. 6 is a flowchart for training and using an evaluation model which may be used in the method of FIG. 2;

FIG. 7 plots the change in loss against training iteration when training the evaluation model;

FIG. 8a plots the probability (confidence) level that a title and keyword pair which is classified as “good” is indeed “good” for each pair (row) in test data;

FIG. 8b plots the number of rows of test data which are in the top, middle and bottom rows shown in FIG. 8a;

FIG. 8c plots the average probability, for each of the top, middle and bottom rows, that a title and keyword pair which is classified as “good” is indeed “good”;

FIG. 8d plots the probability (confidence) level that a title and keyword pair which is classified as “bad” is indeed “bad” for each pair (row) in test data;

FIG. 8e plots the number of rows of test data which are in the top, middle and bottom rows shown in FIG. 8d;

FIG. 8f plots the average probability, for each of the top, middle and bottom rows, that a title and keyword pair which is classified as “bad” is indeed “bad”; and

FIG. 9 plots the change in search ranking over time for example titles, including a title which is newly generated by the method of FIG. 2.

### DETAILED DESCRIPTION

The present techniques relate to systems and methods for generating titles for one or more web pages for a website, with each web page being paired with a particular keyword. The systems and methods use artificial intelligence (AI) and machine learning (ML) which significantly improve the chances of success of Search Engine Optimization (SEO) content when the title is paired with a particular keyword. As explained in more detail below, the present techniques consider the current ranking of titles which are obtained using the keyword on a search engine (e.g. Google™), and then, using the information from the titles which are ranking highly to generate an original title.

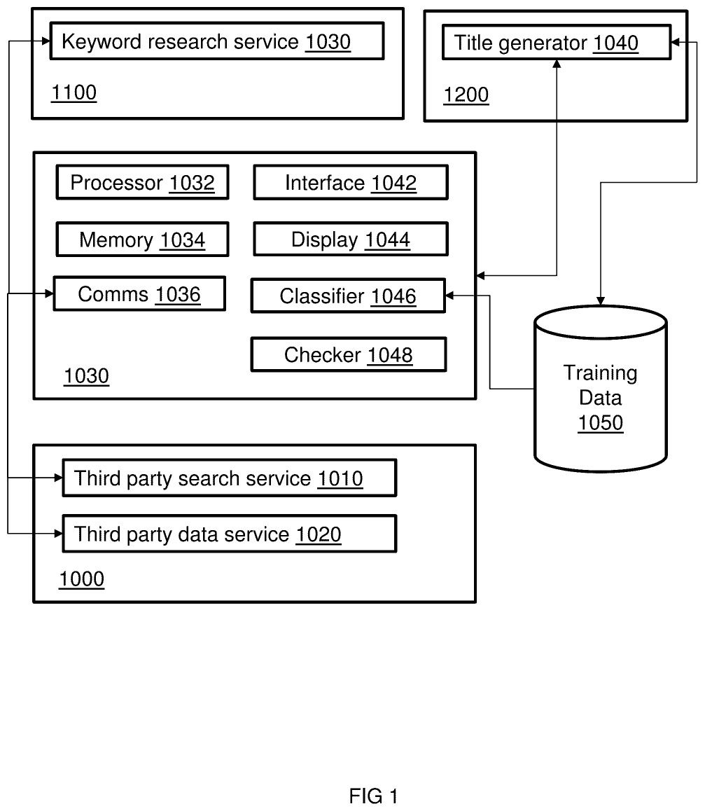

FIG. 1 is a schematic illustration of the system which can be used to implement the method for generating and then selecting keyword and titles for use in search engine optimisation. A keyword may be a single word, e.g. patent, or a string of words or a phrase, e.g. how to file a patent. The keyword is entered by a user (i.e. by a potential customer or consumer) to search for website services or products. A title may also be a single word but is more likely to be a string of words or phrase. The title may have one or more words in common with the keyword. The title is the name of the webpage from a website of the user (i.e. the company or provider) which is offering services or products which are to be targeted to users in the form of customers or consumers.

FIG. 1 comprises a computing device 1030, which may be any suitable electronic device, e.g. a personal computer or computing device, a laptop, a tablet, a smart phone etc. It will be understood that this is a non-exhaustive and non-limiting list of example devices.

FIG. 1 shows some of the components of the computing device 1030, it will be appreciated that there may additionally be other standard components which are not shown. The apparatus comprises at least one processor 1032 (i.e., “processing circuitry”) coupled to memory 1034. The at least one processor 1032 may comprise one or more of: a microprocessor, a microcontroller, and an integrated circuit. The memory 1034 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

The computing device 1030 typically comprises at least one user interface 1042 for a user to input requests, e.g. request for assessing a target keyword. The at least one user interface 1042 may take any appropriate form, e.g. a keyboard, a mouse, a touchpad or other input device. Similarly, the computing device 1030 typically comprises at least one display 1044 for providing the results and/or data generated during the method described below.

The computing device 1030 typically comprises at least one communication module 1036, e.g. a router or similar device, for connecting to at least one remote server 1000. By remote, it is meant that the server is separate from or in another location to the computing device 1030. The remote server 1000. As shown, the computing device 1030 may be able to access one or more services which are provided by the remote server 1000, e.g. by a third party. The services may include a search service 1010 which inputs a target keywords into a target search engine to generate current results and a data service 1020 which provides additional data in relation to a target keyword. In this example, the services are shown as being part of the same server 1000 and could for example be provided by a provider such as dataforseo (https://dataforseo.com/). It will be appreciated that the services may be split across different servers. The communication may be via any suitable means, e.g. via the Internet.

The communication module 1036 may also connect the computing device 1030 to a second server 1100 through which a keyword research service 1030 can be accessed. An example of a keyword research service 1030 is Ahrefs (https://ahrefs.com/) or KW Finder (https://kwfinder.com/) and such a keyword research service can be used to select or generate an initial target keyword as described below. The computing device 1030 may also be connected to a third server 1200 through which a title generator 1040 can be accessed. The title generator 1040 may be a machine learning model as described in more detail below. The title generator 1040 may have been trained on a set of training data in a database 1050. It will be appreciated that the servers 1000, 1100 and 1200 are shown as separate devices but their functionality could be combined into fewer devices or split across more devices as appropriate.

The computing device 1030 also comprises a classifier 1046 which may be any suitable machine learning model. As explained below, the classifier 1046 is used to classify the keyword and title combination. The classifier 1046 is shown as part of the computing device 1030 but it will be appreciated that it may also be external to the computing device 1030 and accessed via the communication module 1036 as explained above in relation to the various services and title generator. The classifier 1046 is also trained on suitable training data which is shown as being stored in the database 1050. It will be appreciated that more than one database for training data may be used.

The computing device 1030 also optionally comprises a checker or checking module 1048. This may also be any suitable machine learning model or AI model. As explained below, the checking module 1048 is used to check that the keyword selected by the process is related to the product or service being offered by the user who wishes to generate a keyword and title combination.

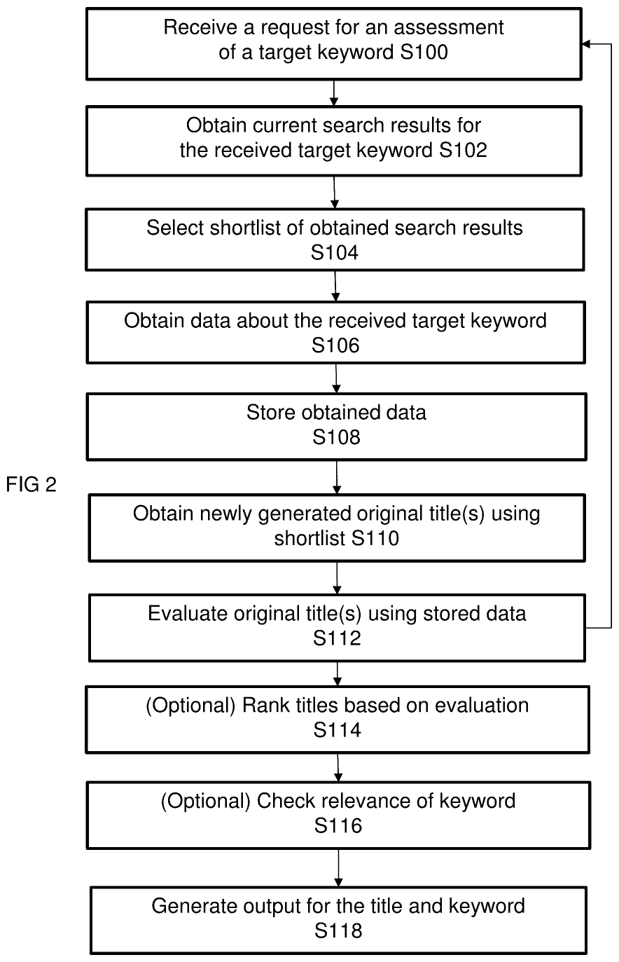

FIG. 2 is a flowchart of the method of the present techniques carried out by the computing device of FIG. 1. In step S100, the method comprises a step of receiving a request for an assessment or evaluation of a specific or target keyword. The request may be received from a user who has generated or otherwise obtained the specific keyword. The request may be input by the user into the user interface of the computing device.

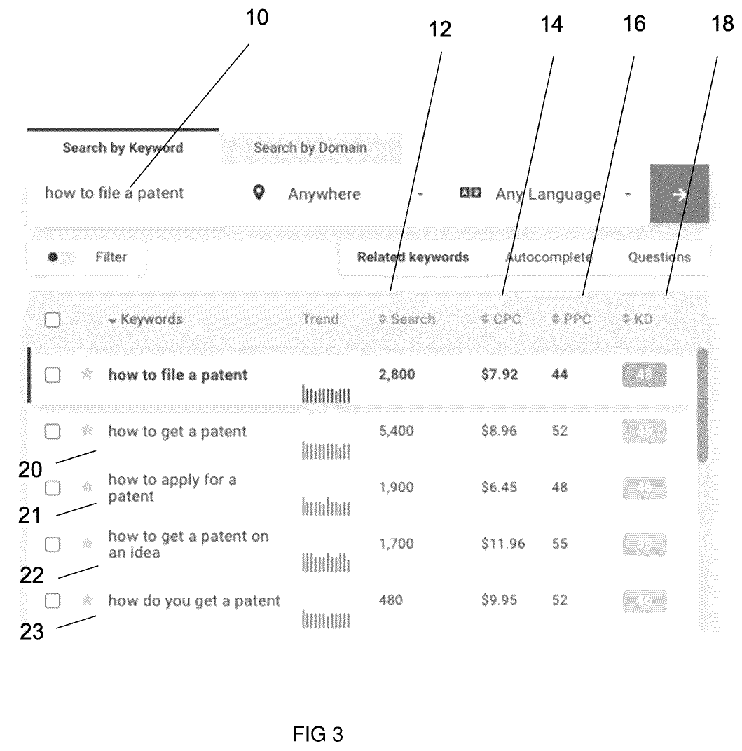

The user may have generated the target keyword by entering an initial keyword in a traditional keyword research tool such as Ahrefs (https://ahrefs.com/) or KW Finder. FIG. 3 shows the exemplary results from a search conducted by such a tool for the keyword “how to file a patent”. As shown such traditional tools provide information about the keyword 10, for example, number of searches per month 12, the cost of ads 14 running against the keyword 14, pay per click (PPC) 16, keyword difficulty (KD) 18, and similar. Suggestions for similar keywords 20, 21, 22, 23 are also typically generated. The same additional information is shown for each of these similar keywords.

Based on these results, the user can make an informed decision and select a target keyword that matches their requirements. For instance, as shown in FIG. 3, the initial keyword “How to file a patent” has a higher number of searches per month with 2,800 searches per month. Only “how to get a patent” has a higher number of searches per month with 5,400 searches per month. If a Google™ Ads were run against the initial keyword, it would cost the user marketing this keyword approximately $7.92 for each click to get a customer to the user's website. This indicates a reasonably strong “purchase intent”. Therefore, it means that it is likely the customer wants to pay somebody to file a patent. This is also the second lowest of the charges which are indicated and thus appears to be good value. Based on these results, the initial keyword “how to file a patent” can be selected by the user as the target keyword. However, given the fine differences between the keywords, it can be difficult to predict the best keyword. Using the method detailed below allows the user to select more than one target keyword for subsequent evaluation. Therefore, advantageously, a wide selection of keywords can be selected and used in the subsequent steps of this method.

It will be appreciated that although the selection of the target keyword by the user is done manually in the example above, this step could be automated by appropriate selection of criteria, e.g. by balancing the cost versus the number of searches and so on.

After the request has been received, the method may further comprise the step S102 of obtaining the current search results for the received target keyword. The current search results may be obtained by any suitable method. For example, the computing device may send the target keyword to a third-party search service to retrieve the current search results in the desired or target search engine (e.g. Google™ or Bing). An example of a suitable third-party service is provided by the provider dataforseo (https://dataforseo.com/). Such a third party search service is specifically for searches in the USA on Google™. But it will be appreciated that other third-party services could be contacted for data from different countries and/or different search engines. The outputted results would be similar for other search engines or locations.

The third party search service typically returns a fixed number of search results, e.g. the top 100 results for the target keyword. The next step S104 is to select a shortlist of a predetermined number of these top results because we want to bias the outcome of the method towards the top performing results. The vast majority of clicks for a keyword go to the results on the first page, and the vast majority of those clicks go to the top three results on the first page. Thus, the aim of the method is to increase the success of content in reaching the first page and the top results on the first page. The predetermined number may for example be selected in the range 5 to 15, for example 12.

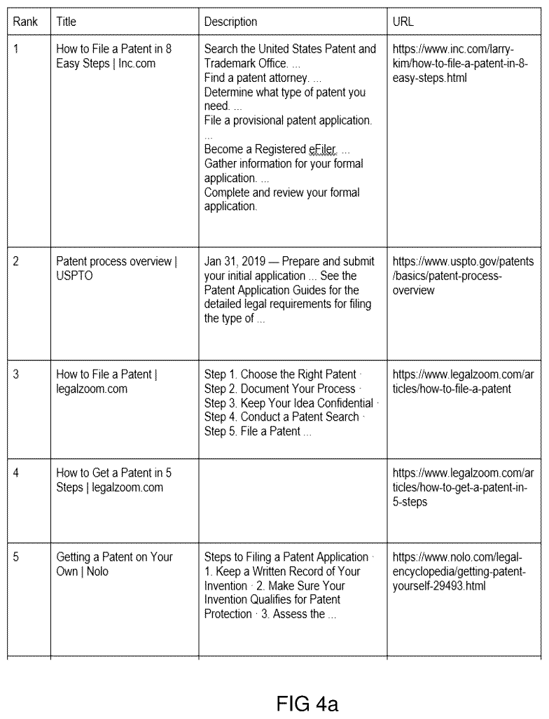

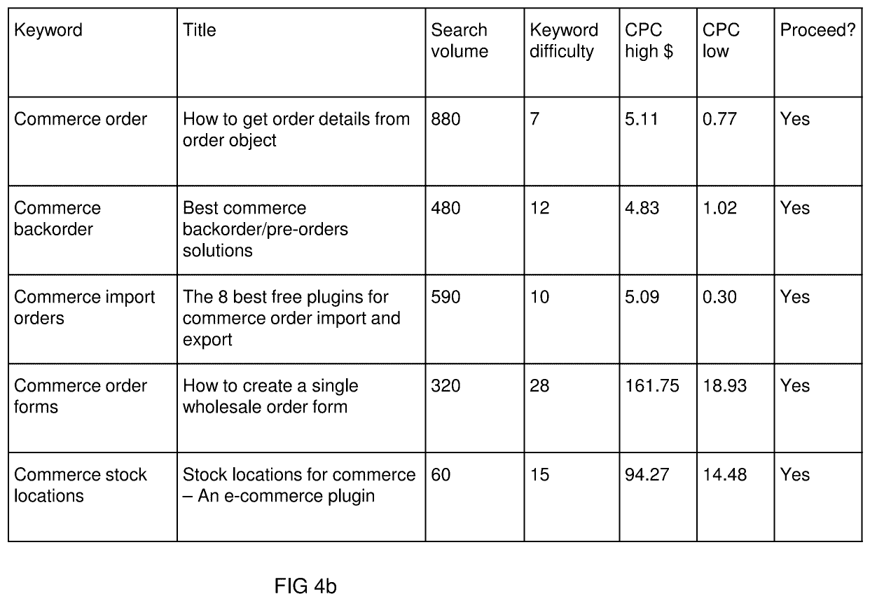

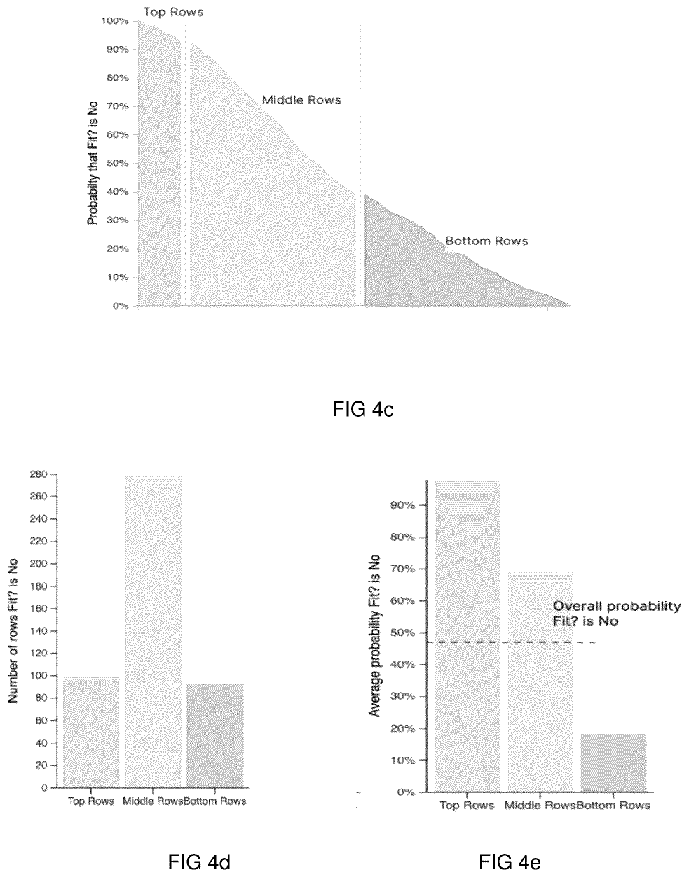

Merely as an example, FIG. 4a shows the top five results for a search for the target keyword “how to file a patent” on the service dataforseo.com. For each result, additional information is shown including at least the rank, the title, a short description and its URL. The skilled person will appreciate that more additional information than is shown in FIG. 4a may be output by the service dataforseo.com. The short description is the text which is typically displayed by a search engine (e.g. Google™) on its results page. The description may be set by the website or generated by the search engine.

Search engines aim to provide a good user experience and one way of achieving this is to reward results which provide a good user experience, i.e. results which are an answer to the question posed by the user. For example, if the user uses the target keyword “how to file a patent”, the search engine will typically monitor which results actually provide the answer to this question. Merely as an example, such monitoring can include monitoring which results a user clicks on and whether the user returns to the search results to find another result. A return to the search results page may be an indication that the user has not received the answer they were looking for when they clicked on a particular result. It will be appreciated that other techniques can be used and these are constantly changing for different search engines. The meta description provided by the website may be rewritten to provide a better indicator of what the website contains or to provide a better answer to a user's question. A meta description is an HTML element that provides a brief summary of a web page. For example, currently the Google™ search engine rewrites the meta description using its own machine learning algorithm approximately 60 to 70% of the time but this may change over time.

The next step S106 is to obtain additional marketing data about the target keyword. This data may be obtained by any suitable method. The marketing data is used to optimise search engine results and thus may be alternatively termed SEO data. For example, the computing device may send the target keyword to a third-party data service to retrieve the marketing data. The third-party data service may be provided by the same provider which provided the third-party search service or may be provided by a different provider. The table below gives example of suitable marketing data which may be obtained in this step, for example from the provider dataforseo for the target keyword “how to file a patent”.

| | Result for “how to file a |
|---|---|
| Data | patent” |
| keyword | how to file a patent |
| competition | MEDIUM |
| competition_index | 44 |
| search_volume | 2900 |
| low_top_of_page_bid | $1.19 |
| high_top_of_page_bid | $7.44 |

As shown above, for each target keyword, the marketing data may include one or more of a competition level, a competition index, a search volume indicator and upper and lower bounds for the cost of the advertisement. The competition level is a level which is representative of the relative amount of competition associated with the target keyword for paid advertisements on this keyword. In this example, the level may be selected from high, medium or low and the level may be determined by the number of advertisers bidding on each keyword relative to all keywords across the search engine (in this case Google™). The competition index also represents the relative amount of competition associated with the given keyword for paid advertisements on this keyword. The competition index value ranges between 0 to 100 (inclusive), wherein 0 value in the competition index indicates that there is no data present. Thus the competition index is a more fine-grained approach than the competition level. The competition index may be determined from the number of advertisement slots which have been filled divided by the total number of slots available. The search volume indicator represents the approximate number per month of searches for the target keyword on the target search engine (e.g. Google™). The lower and upper bounds may be set at predetermined percentages, for example 20% or 80% respectively, of the costs of all advertisements which were displayed. In other words, 20% of the advertisements cost less than the lower bound of $1.19 and 20% of the advertisements cost more than the upper bound of $7.44. As shown, the data may be stored at step S108.

It is noted that this marketing data is more granular than the data typically used by a human evaluator. This is because a machine learning model is able to handle more granular data. This is also a reflection that more granular data can be obtained from some data services such as dataforseo than perhaps from other data services such as KW finder mentioned above.

Using the shortlist of results obtained earlier, the next step S110 is to obtain original titles for the target keyword. The titles may be obtained using any suitable method, for example from title generator which has generated the titles. An example title generator is an AI model such as GPT-3 which is described in “On the Opportunities and Risks of Foundation Models” by Bommasani et al published in 2021. GPT-3 is a foundational AI model which is extremely good at generating text. As explained in more detail below, the title generator may be fine-tuned to specifically generate titles based on what is currently ranking highly in the search results. Any fixed number of titles (e.g. 20) may be generated at this step which is a huge advantage over a human expert who may only be able to think of 5 or 10 options. As an example, the three original results may be “How To File a Patent”, “How to Get a Patent: A Comprehensive Guide to the Process” and “How to Get a Patent: A Step-by-Step Guide”. Merely for comparison with these original titles, the titles from the top 10 search results obtained in step S102 at shown in the table below.

| Search result title | Rank |
|---|---|
| How to File a Patent in 8 Easy Steps | 1 |
| Patent process overview | 2 |
| How to File a Patent | 3 |
| How to Get a Patent in 5 Steps | 4 |
| Getting a Patent on Your Own | 5 |
| How to File a Patent - US Chamber of Commerce | 6 |
| How to File a Patent Application for a New Product or | 7 |
| Invention | |
| How to Apply for a Patent: Everything You Need to | 8 |
| Know | |
| Why should you file a patent application? | 9 |
| How To File a Provisional Patent In 2022 | 10 |

There may be an optional step (not shown) to check that the generated titles are original and not plagiarised. In an example, each one of the generated titles may be checked against the existing titles and if the generated and existing titles exactly match, the method does not proceed further because it indicated a plagiarised title. Comparing the titles in the table above, the newly generated title “how to file a patent” is an exact match for the third ranking search result and could thus be removed from further consideration.

The next step is to evaluate the generated titles at step S112. For each title, the title evaluation step predicts whether the keyword and title combination is likely to provide the desired results (i.e. that the title would appear in the top ranked search results when a user inputs the keyword into the search engine). The title evaluation step may be done by a machine learning model 500 which has been trained to classify the keyword and title combination based on one or more criteria and which may be termed an evaluation model. The criteria may be similar to the data used by the model for generating the title. For example, the criteria may include one or more of:
Keyword for evaluation
New title
Monthly search volume (for the target keyword)
Titles for the selected shortlist of search results (e.g. Google™ results 1 to 12)
Lower bound for cost per click (low bid)
Upper bound for cost per click (high bid)
Meta descriptions for the selected shortlist of search results (e.g. Google™ results 1 to 12)
Full text for the selected shortlist of search results (e.g. Google™ results 1 to 12)
Date of publication for the selected shortlist of search results (e.g. Google™ results 1 to 12)
Competition level for target keyword
Competition index for target keyword
Individual entities contained in each of the selected shortlist of search results (e.g. “US Patent Office”, “US DoJ”, “US Supreme Court” etc.)
Sentiment of the individual entities contained in each of the selected shortlist of search results (e.g. “US Patent Office” may be mentioned negatively in result 1, but positively in result 2. The sentiment of the individual entities is a scale of 0 to 1 for each entity.)
Sentiment of the text in each of the selected shortlist of search results (e.g. result 1 may have an overall positive sentiment, result 2 may have an overall negative sentiment. Sentiment of the text is a scale of 0 to 1 for the whole result.)

The classification provided by the evaluation model may be “good” or “bad”. Each of these “good” and “bad” classifications is subjective. The aim of the “good” classification that the SEO Content (i.e. the content behind the title) could rank in the top 10 for the selected keyword, with a chance of getting to the top 3. The output from the evaluation model may also include a confidence score for each classification, particularly for each positive classification. The confidence score may be out of 1 and may be accompanied by a confidence level or indicator, e.g. “yes”, “no” or “maybe”. Example ranges for the confidence indicators are shown below:

| Confidence score | Indicator of confidence |
|---|---|
| 0.7 to 1.0 | Yes |
| 0.4 to 0.7 | Maybe |
| 0.0 to 0.4 | No |

The evaluation model is able to check multiple pairs of titles and keywords. For example, a first keyword and title pair may be checked and a classification together with a confidence score may be output. The method may then move to the next title to check this title with the keyword and this may be repeated until all of the fixed number of titles (e.g. all 20) have been checked. When all titles are checked for a particular keyword, the method may then repeat steps S100 to S112 for another keyword. It will be appreciated that multiple keywords may be received at step S100 and that the process iteratively repeats steps S102 to S112 for each keyword. In this way, many more keyword and title pairs can be checked than would be possible manually. Information about all titles which have been checked may be output once all titles for a keyword have been checked or may be output when all title and keyword pairs have been checked or after a certain time frame or other limitation has been met.

Each of the checked keyword and title pairs may be ranked based on the classification and associated confidence score as shown at step S114. A higher ranked pair will be classified “good” and have a highest confidence score. It will be appreciated that one or more, even all, title and keyword pairs may be classified as “Bad”. If all the results are classified as “Bad”, this is an indication to the user that the selected keyword which triggered the process was unsuitable and should be avoided. There may still be an optimal title output (i.e. the least worst title). Advantageously, by changing the keyword, this avoids producing online content which could never rank well.

As an optional step S116, there may be a check to make sure that the keyword is relevant, e.g. that the keyword is relevant to the user's product. This is important because a keyword “how to file a patent” is probably of no use to a shoe manufacturer. The check may be made by a checker or checking module 600 and may be done using any suitable technique. For example, a separate checking model 600 which has been trained is used. Inputs to the checking model may be product name, product page text (i.e. description of the product), and the selected keyword. The output of the checking model is “yes” or “no” on the product fit. Product fit “yes” means that the selected keyword is relevant (e.g. related to the user's product). Product fit “no” means that the selected keyword is not relevant (i.e. not related to the user's product). The training data for the checking model may be classified manually by a human. The checking model may be a sparse neural network.

FIGS. 4b to 4d confirm that the training of the checker is accurate. In FIG. 4b, the output that the product fit is “no” are ranked based on the probability/confidence score which is output together with the ranking. The output is ranked as “top”, “middle” or “bottom” based on the set percentile ranges. FIG. 4c plots the number of product fits which are “no” in each “top”, “middle” or “bottom” category which shows that there are significantly more pairs in the “middle” category. FIG. 4d plots the average confidence score for each category and the horizontal line at 48% shows the overall probability that an idea would not be a fit.

As shown, the next step S118 is to generate an output which may be displayed to the user. The output from the title evaluation step is a classification of the keyword and title combination. As explained above, the classification may be a simple “good” or “bad”. The output may also include a confidence level. The classification and confidence level may be displayed for multiple titles for the same keyword together with other useful information. As an alternative to outputting a selection of several titles for each keyword, the output which is displayed to the user may be the top ranked title only and an example output is shown in FIG. 4e.

As shown in FIG. 4e, the output to a user may include a plurality of keywords with the top ranked title for each keyword. In this arrangement, there is a single output of a keyword and title for each keyword entered. In addition to the title and keyword pair, the user may be presented with other useful information which may be selected from the information which has been gathered during the method. For example, one or more of the search volume, the keyword difficulty, the high and low cost bids for each page (CPC high and CPC low) may be shown in the user interface. Other information may also be displayed. Finally, an indication may be provided on whether or not to proceed with the title. In the examples, shown in FIG. 4b, all title and keyword pairs are “yes” in the proceed column and thus a user can proceed with high confidence that they've made a great selection. Being able to check keywords like this means that the user can check keywords at a much larger scale than they would manually.

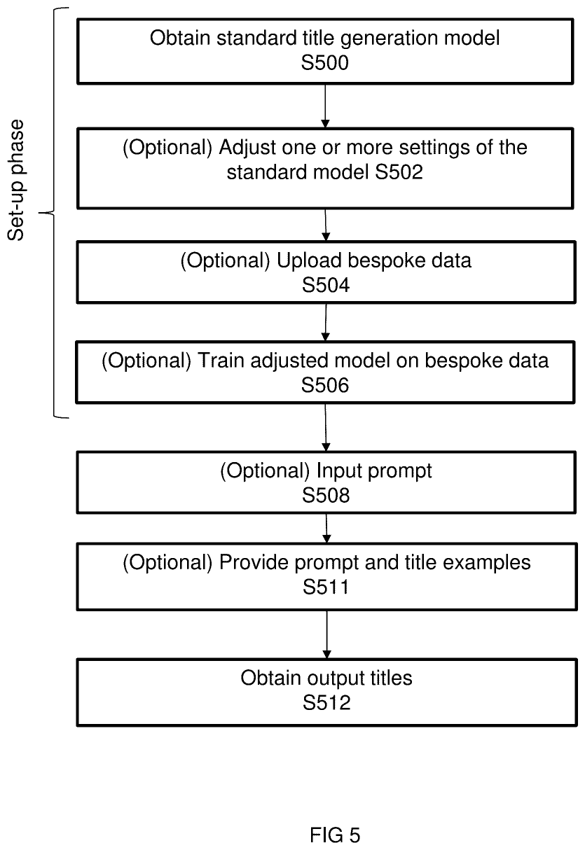

FIG. 5 shows the steps in training and using the title generator. As described in relation to S110, the title generator may use any suitable model for example a foundational AI model which generates text that is often indistinguishable from a human's writing such as the GPT-3 AI model. In a first step S500, a standard title generation model is obtained. Such a title generation model is typically pre-trained and may be obtained from a standard source such as OpenAI, through an API (https://openai.com). For example, the GPT-3 AI model is pre-trained on 175 billion parameters. Therefore, the model already knows all the text one might need for a title on “how to file a patent”. However, there are various steps which can be taken to improve the results from the model.

As shown at step S502, an optional step is to adjust one or more settings of the standard model. These settings include one or more of the temperature of the model, the frequency penalty, the presence penalty and the text limits for inputs and outputs. The temperature of the model controls how original or creative the output (i.e. the generated title) will be relative to the training data which is input to the model. Adjusting the temperature to be higher means that the generated title will be less like titles generated from similar inputs. Conversely, selecting a lower temperature means that the generated title(s) will be much more similar to the titles generated from similar input. The frequency penalty controls levels of repetition in the generated titles compared to the titles in the training data. In other words, the frequency penalty indicates whether the text in the newly generated title repeats the same words as one or more training titles. A higher frequency penalty discourages the generation of titles which repeat words or phrases in the titles in the training data. The presence penalty controls how likely each generated title is to cover new topics which are not covered by the training data. There may be one or more text limits for how many characters may be included in the input, the generated title (output) and the combination of input and output. For example, the character limit may be approximately 2000 for the pair of input and output.

The next optional steps include a fine-tuning of the model to fit the specific use case. As shown at step S504, bespoke data may be uploaded. For example, the bespoke data may be a plurality of inputs and outputs. For the foundational GPT-3 model, the input may be termed a prompt. For example, a simple prompt could be: “Write a title for a blog post on the topic of how to file a patent”. The output is a generated title, e.g. “Filing a Patent: The Ultimate Guide”. The bespoke data may include hundreds or thousands of examples of original titles and potentially the prompts from which these titles were generated. In addition to the titles and prompts, any or all of the content and/or marketing data which has been gathered in the search stage S102 or the obtaining stage S108 may be uploaded. In other words, the titles of the top results in a search engine, the search volume, ad information and any other similar information may be uploaded. In another example, the meta descriptions of the titles may also be uploaded as the training data. It is noted that although the bespoke data for the fine-tuning of the title generator may use some or all of the content and/or marketing data which is also used in the evaluation (i.e. classification) model, the bespoke data does not need to match the training data used for the evaluation model.

At step S506, the bespoke data may be used to train the standard model. Any suitable training method may be used to fine-tune the model. Merely as an example, one process for fine-tuning language models is described in “Process for Adapting Language Models to Society (PALMS) with Values-Targeted Datasets” by Solaiman et al published as arXiv:2106.10328 in June 2021. Returning to the currently described process, the fine-tuned model may generate titles based on what is currently ranking in the desired search engine (e.g. Google™). The fine-tuned model may be using the titles of the top results, the search volume and ad information and possibly the meta descriptions, so that the generated results (i.e. generated titles) closely match the search intent. Steps S500 to S506 may be considered to be a set-up phase.

Once the model has been adapted as required, the model may be used to generate one or more titles. As shown at step S508, there is an input to generate a title. The input which is used to generate the title will depend on the model being used.

For example, in order to obtain a good response from the foundational GPT-3 model, i.e. a model without fine-tuning, it may be beneficial to provide a prompt to the model. For example, a simple prompt could be: “Write a title for a blog post on the topic of how to file a patent.” The input may include the keyword “how to file a patent” and instructions to the model on the generation of the output. As an example, inputting this prompt may return the generated title: “Filing a Patent: The Ultimate Guide”. Conversely, in the fine-tuned GPT-3 model, the “prompt” is not required for the generation of an optimal output because the fine-tuned GPT-3 model has the ability to arrive at the optimal output based on the bespoke data uploaded in S504.

When a prompt is used as part of the input request in step S508, it is possible to refine the prompt as an additional or different way to improve the output. Refining the prompt may be achieved by providing examples of inputs (i.e. prompts) and outputs (i.e. titles). The examples may be sent as part of the input. An example of a refined prompt is shown below. In this instance, the prompt “Write a title for a blog post on the topic how to file a patent”: has been reformulated and examples of outputs for the reformulated prompts have been included along with the example prompts.

| Example prompt | Example title |
|---|---|
| Write a title for a blog post on the topic | Should you file a patent: |
| should you file a patent: | ultimate guide |
| Write a title for a blog post on the topic | “Where to file a patent: |
| where to file a patent: | ultimate guide” |

Merely as an example, inputting the prompt “Write a title for a blog post on the topic how to file a patent” may return the generated title: “Filing a Patent: The Ultimate Guide”. The generated title when providing the examples together with the prompt may be “How to file a patent: ultimate guide”. Refining prompts and inputting them to the model, particularly for the foundational GPT-3 model is beneficial and yields better results than providing a simple prompt or no prompt at all. It will be appreciated by the skilled person that fine-tuned GPT-3 model does not require any prompt input.

As shown at step S510, the title generator generates a plurality of titles based on the input received at step S508. These generated titles are then output at step S512. As explained previously, the number of titles which are output can be set by the user and may be significantly higher than the number of titles which could be considered by a manual process.

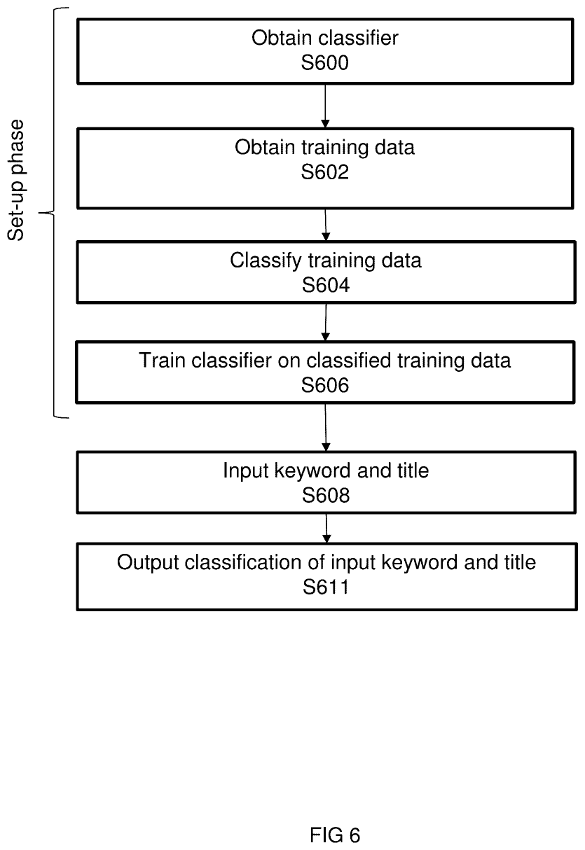

FIG. 6 is a flowchart showing the steps of training and using the classifier (also termed evaluation model) which evaluates the keyword and title pair. In a first step S600, a classifier is obtained. The classifier may be a machine learning model and may be expressed as:

y=Xβ+ϵ

where y is the classification and y∈ [symbol] ⁿ, x is the input data in the form of a vector and x∈ [symbol] ^{n×p}, β are the set of trainable parameters (or weights for the model) and β∈ [symbol] ⁿ and ϵ is the slack variable and ϵ∈ [symbol] ⁿ. The input data comprises a plurality of different types of data, including the keyword and new title together with many of the following categories:
Monthly search volume (for the target keyword)
Titles for the selected shortlist of search results (e.g. Google™ results 1 to 12)
Lower bound for cost per click (low bid)
Upper bound for cost per click (high bid)
Meta descriptions (e.g. summary) for the selected shortlist of search results (e.g. Google™ results 1 to 12)
Full text (e.g. all text on the webpage) for the selected shortlist of search results (e.g. Google™ results 1 to 12)
Date of publication for the selected shortlist of search results (e.g. Google™ results 1 to 12)
Competition level for target keyword
Competition index for target keyword
Individual entities contained in each of the selected shortlist of search results (e.g. “US Patent Office”, “US DoJ”, “US Supreme Court” etc.)
Sentiment of the individual entities contained in each of the selected shortlist of search results (e.g. “US Patent Office” may be mentioned negatively in result 1, but positively in result 2. The sentiment of the individual entities is a scale of 0 to 1 for each entity.
Sentiment of the text in each of the selected shortlist of search results (e.g. result 1 may have an overall positive sentiment, result 2 may have an overall negative sentiment. Sentiment of the text is a scale of 0 to 1 for the whole result.

The training data is gathered by using existing keyword and titles and performing the searches and additional data gathering as described above in steps S102 and S106 of FIG. 2. A large volume of data is ideally gathered to improve the accuracy of the results. For example, 2500 rows of input data may be gathered. Once the data is gathered, as shown at step S604, the data is classified. In other words, the keyword and title pair are classified as “good” or “bad” if these are the classifications being used. The classification may be done manually based on the historical performance of the gathered keyword and title pairs over a fixed time period, e.g. months or years, perhaps 4 years.

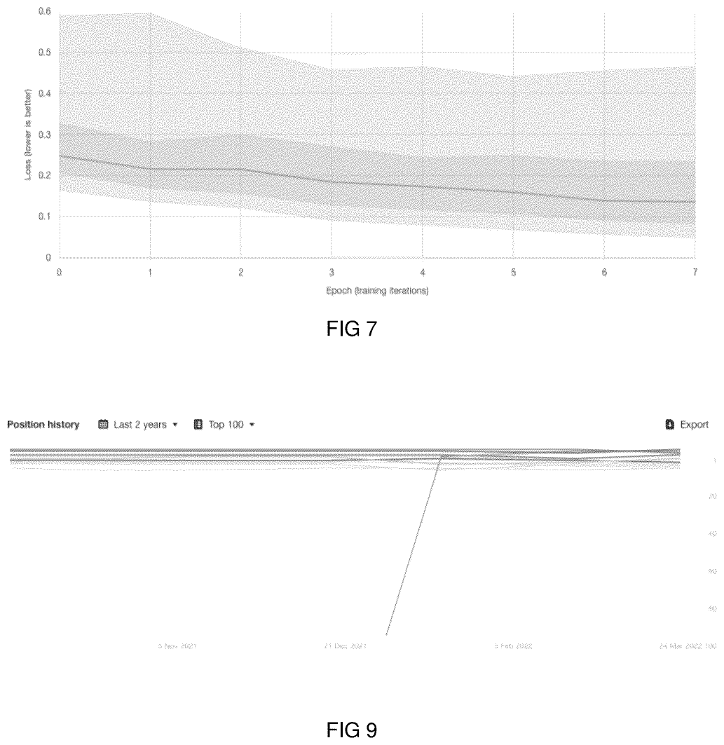

Once the data is classified, the model may be trained on the classified data as noted at step S606. It will be appreciated that the training may be done using any suitable technique. However, it is expected that only a small number of the categories for the data are likely to contribute to the classification so a sparse neural network is a particularly suitable model and thus training techniques for such a model are particularly useful. For example, in a sparse neural network, many of the weights are set to 0 by imposing a penalty λ on the set of weights β. The loss function for training the sparse neural network may thus be written as:

$${arg min}_{β} {‖ y - X β ‖}_{2}^{2} + λ {‖ β ‖}_{0}$$

where ∥ . . . ∥ is the [symbol] ₀ norm that counts the number of non-zero entities and ∥ . . . ∥₂² is squared [symbol] ₂ norm. This loss function can be solved in any way, for example by approximating the [symbol] ₀ norm by the [symbol] ₁ norm and using lasso regression or other regularization techniques. Multiple optimization stages may be used to fit the model to the data. Merely as an example, FIG. 7 shows how the loss decreases with the training iterations. In this example, there are 7 iterations for the training process but it will be appreciated that the number of iterations can be selected to achieve the desired level of accuracy.

Steps S600 to S606 thus represent a set-up phase and once the model is trained, the model may be used. Thus, at step S608, the keyword and title to be evaluated can be input together with all the related data which is available and which has been gathered in the search and data gathering steps S102 and S106 of the method of FIG. 1. The title evaluator will then output a classification of the input, optionally with a confidence level as noted above.

The sparse neural network has a good performance for this classification task and the table below gives some example results:

Good post idea - Overall accuracy - 83.26

| Good - excellent | Bad - excellent |
|---|---|
| 304/343 predicted correctly | 91/141 predicted correctly |
| 42 false positives | 39 false positives |
| Rows predicted “good” | Rows predicted “bad” |
| are 24% more | are 146% more |
| likely to be “good” than average | likely to be “bad” than average |
| Precision - 0.879 | Precision - 0.717 |
| Recall - 0.886 | Recall - 0.702 |
| F1 (combines precision and recall to give | F1 - 0.710 |
| overall accuracy) - 0.882 | |

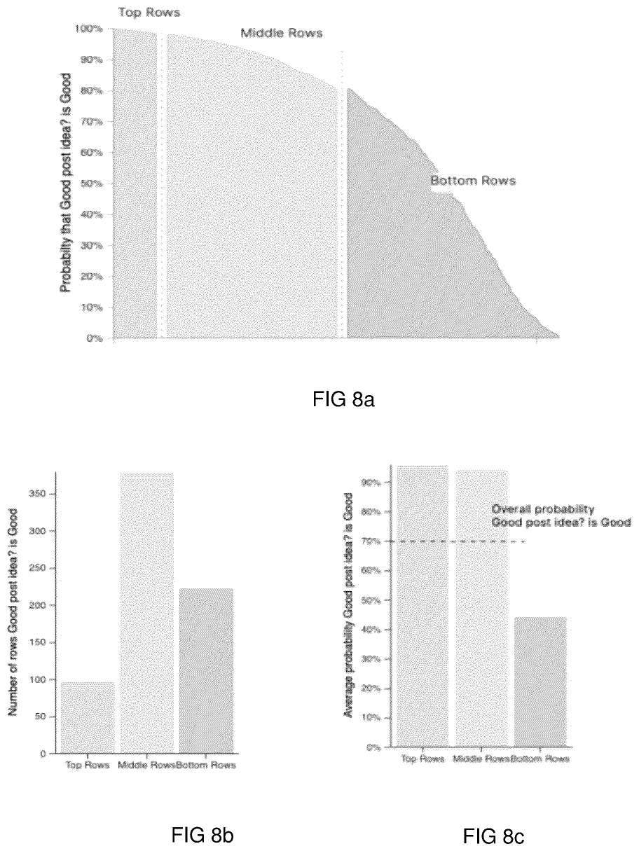

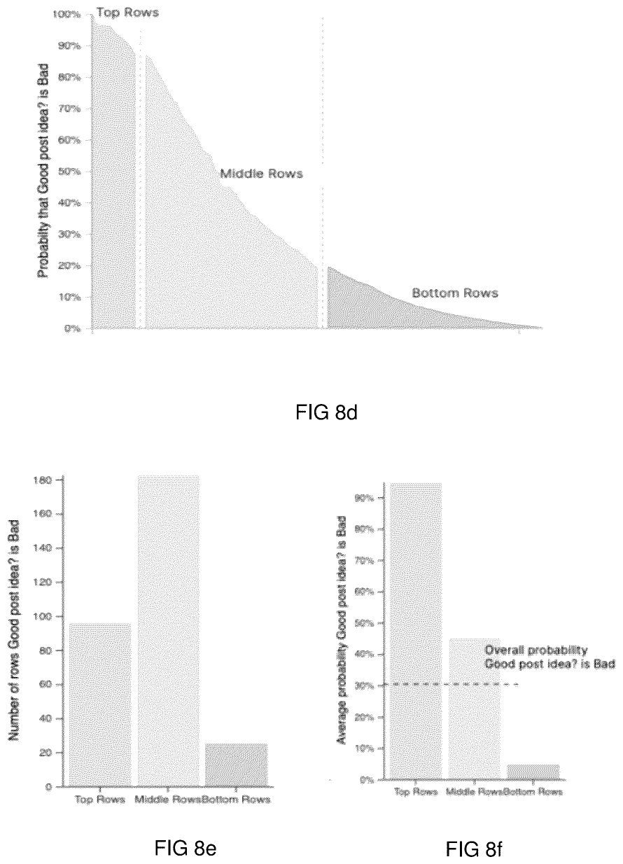

FIGS. 8a and 8f show further test results to illustrate the improved accuracy of the method. In FIG. 8a, a plurality of title and keywords pairs together with the other data provided (i.e. the row of information for each title and keyword pair) which have been classified as “good” are ranked based on the probability/confidence score which is output together with the ranking. The pairs are ranked as “top”, “middle” or “bottom” based on the set percentile ranges. The information for the top rows, middle rows and bottom rows is shown in the tables below:

| | Top rows | Middle rows | Bottom rows |
|---|---|---|---|
| Accuracy (%) | 96.0 | 94.8 | 73.2 |
| Prediction range | 1.00-0.98 | 0.98-0.81 | 0.80-0.00 |
| Percentile range (%) | 100.0-90.0 | 90.0-50.1 | 50.1-0.2 |
| Total number | 97 | 380 | 222 |
| Probability of “good” | 139.0 | 135.8 | 63.5 |
| classification (compared to | | | |
| overall probability) | | | |

FIG. 8b plots the number of title and keyword pairs in each category which shows that there are significantly more pairs in the “middle” category. FIG. 8c plots the average confidence score for each category and the horizontal line at 70% shows the overall probability that an idea for a good post would be classified “good”. The table shows that the probability that any of the pairs in the top or middle rows is a good combination is high when compared to the overall probability and thus the method is successful in generating good results.

FIGS. 8d to 8f provide similar information for the keyword and title pairs which are classified as “bad”. FIG. 8d shows the rankings as “top”, “middle” or “bottom” based on the percentile range. The information for the top rows, middle rows and bottom rows is shown in the tables below:

| | Top rows | Middle rows | Bottom rows |
|---|---|---|---|
| Accuracy (%) | 95.0 | 67.8 | 95.0 |
| Prediction range | 1.00-0.878 | 0.87-0.19 | 0.19-0.00 |
| Percentile range (%) | 100.0-90.0 | 90.0-50.1 | 50.1-0.2 |
| Total number | 96 | 183 | 25 |
| Probability of “bad” | 316.4 | 150.4 | 16.4 |
| classification (compared to | | | |
| overall probability) | | | |

FIG. 8e plots the number of title and keyword pairs in each category which shows that there are significantly more pairs in the “middle” category. FIG. 8f plots the average confidence score for each category and the horizontal line at 30% shows the overall probability that an idea for a good post would be classified “bad”. The table shows that the probability that any of the pairs in the top rows is bad is much higher than the overall probability and thus these results should be avoided.

FIG. 9 illustrate another indicator of the success of the method. FIG. 9 plots the change in position over time for several titles when using a particular keyword. Most of the titles which are ranking at the top are stable over the period from November 2021 to March 2022 when the data was captured. As shown, a new title which has been predicted by the above described method is introduced in late December 2021. Initially, the new title has a relatively low rank but in a short period of time, i.e. just a month, the new title is ranking in the top five titles and remains in the top five titles for the remainder of the period. Using past techniques, it would normally have taken several months, e.g. 6 months, to achieve the same ranking. The method above has achieved this by automatically generating a title that perfectly matches the search intent and it can do this because the title is generated based on what's currently ranking for the target keyword.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors (also referred to herein as “processing circuitry”). These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

Although many implementation details and example have been described, these should not be construed as any limitation on the scope of what is claimed. The scope extends to any novel one, or any novel combination, of the features disclosed in this specification (including any accompanying claims, abstract and drawings), or to any novel one, or any novel combination, of the steps of any method or process so disclosed.

1. A computer-implemented method for generating a webpage title using a computing device having at least one machine learning model, the method comprising:
receiving, at the computing device, a request for an assessment of at least one target keyword, wherein each of said at least one target keywords comprises at least one word which is input to a search engine by a user to conduct a search for content;
obtaining, from a search service, current search results for the at least one target keyword on at least one search engine, wherein the current search results are ranked and include content information;
selecting, using the computing device, a shortlist of search results from the obtained current search results;
obtaining, from a data service, marketing data for the at least one target keyword;
obtaining, from a title generator, a plurality of titles for each of the at least one target keywords, wherein the plurality of titles are generated by the title generator using the shortlist of the obtained search results;
evaluating, using an evaluation model comprising a machine learning model, the plurality of generated titles to classify each combination of generated title and target keyword, wherein the evaluation model is configured to generate a classification for each combination of generated title and target keyword using the marketing data for the target keyword and the content data for the shortlist of search results; and
outputting, on a user interface of the computing device, at least one an optimal title based on the classification from the evaluation model.

2. The method of claim 1, wherein the evaluation model is a sparse neural network.

3. The method of claim 1, wherein the evaluation model has been previously trained using training data including at least content data from high ranking search results which have been obtained using a keyword and marketing data for the keyword used to obtain the search results.

4. The method of claim 1, wherein evaluating using the evaluation model comprises
generating, using the evaluation model, a confidence score for each classification for the evaluation model.

5. The method of claim 4, wherein
evaluating using the evaluation model comprises ranking each generated title based on the generated confidence score; and
outputting at least one optimal title comprises outputting an optimal title which is the generated title having the highest rank.

6. The method of claim 1, wherein the marketing data includes at least one of a search volume indicator which represents the approximate number of searches for the at least one target keyword, a competition level which is a level representing the relative amount of competition associated with the target keyword for paid advertisements on the target keyword, a competition index which is a score representing the relative amount of competition associated with the target keyword for paid advertisements on the target keyword, a lower bound for a cost of a paid advertisement for the target keyword and a upper bound for a cost of a paid advertisement for the target keyword.

7. The method of claim 1, wherein the content data includes at least one of the title for each search result, a meta description for each search result, a full text description for each search result and a date of publication for each search result.

8. The method of claim 1, wherein the title generator is a machine learning model which has been previously trained using training data including at least content data from high ranking search results which have been obtained using a keyword and marketing data for the keyword used to obtain the search results.

9. A system for generating a webpage title, the system comprising a computing device which comprises memory containing instructions, an evaluation model and processing circuitry that executes the instructions, wherein the processing circuitry is configured to:
receive a request for an assessment of at least one target keyword, wherein each of the at least one keywords comprises at least one word which is input to a search engine by a user to conduct a search for content;
obtain, from a search service, current search results for the at least one target keyword on at least one search engine, wherein the current search results are ranked and include content information;
select a shortlist of search results from the obtained current search results;
obtain, from a data service, marketing data for the at least one target keyword;
obtain, from a title generator, a plurality of titles for each of the at least one the target keywords, wherein the plurality of titles are generated by the title generator using the shortlist of the obtained search results;
evaluate, using the evaluation model, the plurality of generated titles to classify each combination of generated title and target keyword, wherein the evaluation model is configured to generate a classification for each combination of generated title and target keyword using the marketing data for the target keyword and the content data for the shortlist of search results; and
output, on a user interface of the computing device, at least one an optimal title based on the classification from the evaluation model.

10. The system of claim 9, wherein the evaluation model is a sparse neural network.

11. The system of claim 9, wherein the evaluation model has been previously trained using training data including at least content data from high ranking search results which are obtained using a keyword and marketing data for the keyword using to obtain the search results.

12. The system of claim 11, wherein the evaluation model is further configured to generate a confidence score for each generated classification.

13. The system of claim 12, wherein the evaluation model is further configured to rank each generated title based on the generated confidence score and wherein the processing circuitry is configured to output a single optimal title which is the generated title having the highest rank.

14. The system of claim 9, wherein the title generator is a machine learning model which has been previously trained using training data including at least content data from high ranking search results which have been obtained using a keyword and marketing data for the keyword used to obtain the search results.

15. A non-transitory computer-readable medium storing a plurality of computer instructions executable by a computing device, wherein the plurality of computer instructions, when executed by processing circuitry of the computing device, cause the computing device to:
receive, at the computing device, a request for an assessment of at least one target keyword, wherein each of the at least one target keywords comprises at least one word which is input to a search engine by a user to conduct a search for content;
obtain, from a search service, current search results for the at least one target keyword on at least one search engine, wherein the current search results are ranked and include content information;
select, using the computing device, a shortlist of search results from the obtained current search results;
obtain, from a data service, marketing data for the at least one target keyword;
obtain, from a title generator, a plurality of titles for each of the at least one target keywords, wherein the plurality of titles are generated by the title generator using the shortlist of the obtained search results;
evaluate, using an evaluation model comprising a machine learning model, the plurality of generated titles to classify each combination of generated title and target keyword, wherein the evaluation model is configured to generate a classification for each combination of generated title and target keyword using the marketing data for the target keyword and the content data for the shortlist of search results; and
output, on a user interface of the computing device, at least one an optimal title based on the classification from the evaluation model.

16. The non-transitory computer-readable medium of claim 15, wherein the evaluation model is a sparse neural network.

17. The non-transitory computer-readable medium of claim 15, wherein the evaluation model has been previously trained using training data including at least content data from high ranking search results which have been obtained using a keyword and marketing data for the keyword used to obtain the search results.

18. The non-transitory computer-readable medium of claim 15, wherein the evaluation model is further configured to generate a confidence score for each classification generated by the evaluation model.

19. The non-transitory computer-readable medium of claim 15, wherein the evaluation model is further configured to rank each generated title based on the generated confidence score and the plurality of computer instructions further cause the computing device to output an optimal title which is the generated title having the highest rank.

20. The non-transitory computer-readable medium of claim 15, wherein the title generator is a machine learning model which has been previously trained using training data including at least content data from high ranking search results which have been obtained using a keyword and marketing data for the keyword used to obtain the search results.
